(19) United States
(12) Patent Application Publication
(10) Pub. No.: US 2006/0265737 A1
(43) Pub. Date: Nov. 23, 2006

(54) Methods, systems, and computer program products for providing trusted access to a communicaiton network based on location

(76) Inventor: Robert P. Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/135,086

(22) Filed: May 23, 2005

(51) Int. Cl. H04L 9/32

(52) U.S. Cl. 726/3

(57) ABSTRACT

Methods, systems, and computer program products for providing trusted access to a communication network by a client based on location. An available access network providing access to a target communication network is detected. A determination is made as to whether the available access network is a trusted access network. In response to determining that the available access network is not a trusted access network, location information for the client is determined. An identity of at least one trusted access network is determined based on the determined location information.

### RELATED APPLICATIONS

This application is related to a commonly assigned U.S. patent application Ser. Nos. 11/093,355 and 11/093,564, entitled, respectively, “Methods, Systems, and Computer Program Products for Determining a Trust Indication Associated with Access to a Communication Network” and “Methods, Systems, and Computer Program Products for Establishing Trusted Access to a Communication Network”, both filed on Mar. 30, 2005, the content of both being incorporated by reference herein in their entirety.

### TECHNICAL FIELD

The subject matter described herein relates to communications with a network. More particularly, the subject matter described herein relates to providing trusted access to a communication network based on a location of the client.

### BACKGROUND

Advancements in communication technologies have led to expansive growth in the availability and use of communication networks. For example, the Internet's ubiquitous nature and limitless supply of practical applications has fueled a rapid growth in providing access to the Internet to users wherever they may be across the world. Such access may be provided with or without the use of security, authentication, and encryption technologies, depending on the user's requirements. Common methods of access include dial-up, landline broadband (over coaxial cable, fiber optic cables or copper wires), wireless broadband, and satellite.

Many public places, such as airports, libraries, Internet cafes, and businesses provide access to the Internet to cater to users away from their home or business. Internet access points in some public places, like airport halls, are sometimes designed just for brief use while standing. Various terms such as “public Internet kiosk”, “public access terminal”, and “Web payphone” have been used to describe these access points.

Wi-Fi provides wireless access to communication networks, and therefore may provide Internet access. Wi-Fi “hotspots” providing such access include Wi-Fi cafes, where a potential user typically brings his or her own wireless-enabled device, such as a notebook computer or personal digital assistant (PDA). These services may be free to all, free to customers only, or fee-based. A hotspot need not be limited to a confined location. Whole campuses, parks, and even metropolitan areas have been Wi-Fi enabled.

With many people using Wi-Fi hotspots and other access points to access the Internet and other communication networks, new security threats arise from the access provider and other users of the access point. Access is typically provided via networks that are privately owned by individuals or small companies where the user doesn't know the owner. It's a simple matter for the owner to “sniff” traffic on his network on the way to the Internet to steal personal information from the users of the network.

In addition, many business and residential users do not botherto protect their network. As a result, others in close proximity to the business or network can gain unauthorized access to the user's network. For example, users have been known to identify locations that provide unsecured access, such as active Wi-Fi access points, either by physically marking a building or sidewalk with chalk or by placing its street address on a Website of hotspots. This technique is commonly referred to as “warchalking”. Another technique, commonly referred to as “wardriving”, involves users driving around an area with a notebook computer with wireless capabilities in order to find unsecured Wi-Fi hotspots. The goal here is to find vulnerable sites either to obtain free Internet service or to potentially gain illegal access to an organization's or other user's data.

Early attempts to provide security included changing or suppressing a service set identifier (SSID) associated with a Wi-Fi access point and/or only allowing access by devices with specific addresses. These methods are easily defeated by hackers armed with packet sniffers and address spoofing equipment. In addition, precautions that hide an access point or limit computers that can access the access point are not practical in commercial applications when the access provider provides the access point to users as a service.

Other possible security precautions that may be taken by a user include the use of a firewall at the user's device. Firewalls, however, only help protect the user's device and data thereon, but provide no protection for the data that is sent and received from the device to/from a communication network.

Virtual private networks (VPNs) have also been used to provide access to a trusted, usually private network. The use of VPNs, however, also has several disadvantages, such as creating excessive traffic on the private trusted networks. In addition, VPN use often results in significant performance degradation for the user. For example, the VPN server may not be near the user's local network or the VPN server may not be designed for high-speed access, just occasional access from remote clients to the trusted network.

Other available precautions include the use of certificate authorities such as VERISIGN™ and THAWTE™ to provide an identity service where they guarantee the identity of a device by providing the device with a digital certificate with identification information. The digital certificate is signed by one or more certificate authorities that a receiving device or user trusts. Trust exists because the digital signatures of the certificate authorities are difficult to forge, and the certificate authorities themselves have established trust throughout the user community, usually through marketing and branding. Certificate authorities, however, simply verify identity. For example, they can verify that a website “my.website.com” or server that is accessed is indeed my.website.com. Certificate authorities do not guarantee anything further about the remote service or device. The certificate authority's signature is the symbol of the guarantee. VERISIGN™, for example, will allow a website to place the VERISIGN™ logo on the site to verify that the site is secure. The logo provides assurance to users of the identity of the site and assures that all information sent to the site is sent using the secure sockets layer (SSL) security protocol.

None of the above-mentioned security precautions provides assurances that access provided to a communication network, such as via a Wi-Fi hotspot or other access point, can be trusted.

Commonly assigned U.S. patent application Ser. Nos. 11/093,355 and 11/093,564, referenced above, relate to methods and systems that can be used to determine if a network can be trusted. U.S. patent application Ser. No. 11/093,355 relates to determining a trust indication associated with an access network providing access to a communication network. A trust-related characteristic of an access network providing access to a target communication network is determined. A trust indication for the access network is determined based on the determined trust-related characteristic. The determined trust indication is associated with the access network and is made available to clients detecting the access network. The trust indication is originated by a trust authority that is separate from the client and from the access network.

U.S. patent application Ser. No. 11/093,564 relates to establishing trusted access to a communication network by a client. The client detects an available access network providing access to a target communication network and determines a trust indication associated with the available access network. The trust indication is originated by a trust authority that is separate from the client and from the available access network. A determination of whether to access the communication network via the available access network is made at the client based on the trust indication. The trust-related characteristics and the trust indication are determined by the trust authority, which makes the determined trust indication available to clients detecting the access network. For example, a trust indication message may be sent to a client prior to providing access by the client to the target communication network. The access is provided based on a response by the client to the received trust indication message.

When a user is attempting to access a communication network via an untrusted access network, however, it would be helpful for the user to have the ability to identify one or more trusted access networks based on a location of the user/client.

U.S. Publication No. 2002/0138635 to Redlich et al. describes a system comprising a client device, an access station, and a trusted network element. In Redlich's system, an ISP can select a trusted network node based on a user's security requirements and an access station's location. Redlich, however, does not provide trusted access to a communication network based on a client's location.

Accordingly, there exists a need for methods, systems, and computer program products for providing trusted access to a communication network based on location information.

### SUMMARY

In one aspect of the subject matter disclosed herein, a method is disclosed for providing trusted access to a communication network by a client based on location. The method includes detecting an available access network providing access to a target communication network, determining whether the available access network is a trusted access network, determining location information for the client responsive to determining that the available access network is not a trusted access network, and determining an identity of at least one trusted access network based on the determined location information.

In another aspect of the subject matter disclosed herein, a method is disclosed for providing trusted access to a communication network by a client based on location. The method includes determining location information for the client and determining an identity of at least one trusted access network based on the determined location information.

In another aspect of the subject matter disclosed herein, a method is disclosed for providing trusted access to a communication network to a client based on location. The method includes receiving a request for an identity of at least one trusted access network for accessing a target communication network at a server from the client. The request includes at least one of an access network identifier associated with an access network currently available to the client and location information for the client. Corresponding information for at least one trusted access network is determined based on the at least one of a network identifier for an access network currently accessible to the client and location information for the client. The corresponding information for the at least one trusted access network is forwarded to the client.

In another aspect of the subject matter disclosed herein, a computer program product is disclosed. The computer program product includes computer executable instructions embodied in a computer-readable medium for performing steps at a client including detecting an available access network providing access to a target communication network, determining whether the available access network is a trusted access network, determining location information for the client responsive to determining that the available access network is not a trusted access network, and determining an identity of at least one trusted access network based on the determined location information.

In another aspect of the subject matter disclosed herein, a computer program product is disclosed. The computer program product includes computer executable instructions embodied in a computer-readable medium for performing steps including determining location information for the client and determining an identity of at least one trusted access network based on the determined location information.

In another aspect of the subject matter disclosed herein, a computer program product is disclosed. The computer program product includes computer executable instructions embodied in a computer-readable medium for performing steps including receiving a request for an identity of at least one trusted access network for accessing a target communication network at a server from a client. The request includes at least one of an access network identifier associated with an access network currently available to the client and location information for the client. The performed steps also include determining corresponding information for at least one trusted access network based on the at least one of a network identifier for an access network currently accessible to the client and location information for the client and forwarding the corresponding information for the at least one trusted access network to the client.

In another aspect of the subject matter disclosed herein, a communication device for providing trusted access to a communication network based on location includes means for detecting an available access network providing access to a target communication network, means for determining whether the available access network is a trusted access network, means for determining location information for the client, and means for determining an identity of at least one trusted access network based on the determined location information.

In another aspect of the subject matter disclosed herein, a communication device for providing trusted access to a communication network based on location includes a network interface that detects an available access network providing access to a target communication network, a location manager that determines location information for the communication device, and a network information manager that determines whether the available access network is a trusted access network and, responsive to determining that the available access network is not a trusted access network, determines an identity of at least one trusted access network based on the determined location information.

In another aspect of the subject matter disclosed herein, a server for providing trusted access to a communication network by a client includes means for receiving a request for an identity of at least one trusted access network for accessing a target communication network from a client. The request includes at least one of an access network identifier associated with an access network currently available to the client and location information for the client. The server also includes means for determining corresponding information for at least one trusted access network based on the at least one of a network identifier for an access network currently accessible to the client and location information for the client and means for forwarding the corresponding information for the at least one trusted access network to the client.

In another aspect of the subject matter disclosed herein, a server for providing trusted access to a communication network by a client includes a client interface that receives a request for an identity of at least one trusted access network for accessing a target communication network from a client. The request includes at least one of an access network identifier associated with an access network currently available to the client and location information for the client. The server also includes a network information manager that determines corresponding information for at least one trusted access network based on the at least one of a network identifier for an access network currently accessible to the client and location information for the client. The client interface forwards the corresponding information for the at least one trusted access network to the client.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a schematic diagram illustrating a system for providing trusted access to a communication network based on location according to an aspect of the subject matter disclosed herein;

FIG. 2 is a representation of a user interface for selecting among access networks;

FIG. 3 is a flow diagram illustrating a method for providing trusted access to a communication network by a client based on location according to an aspect of the subject matter described herein;

FIG. 4 is a flow diagram illustrating a method for providing trusted access to a communication network by a client based on location according to another aspect of the subject matter described herein; and

FIG. 5 is a flow diagram illustrating a method for providing trusted access to a communication network to a client based on location according to another aspect of the subject matter described herein.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

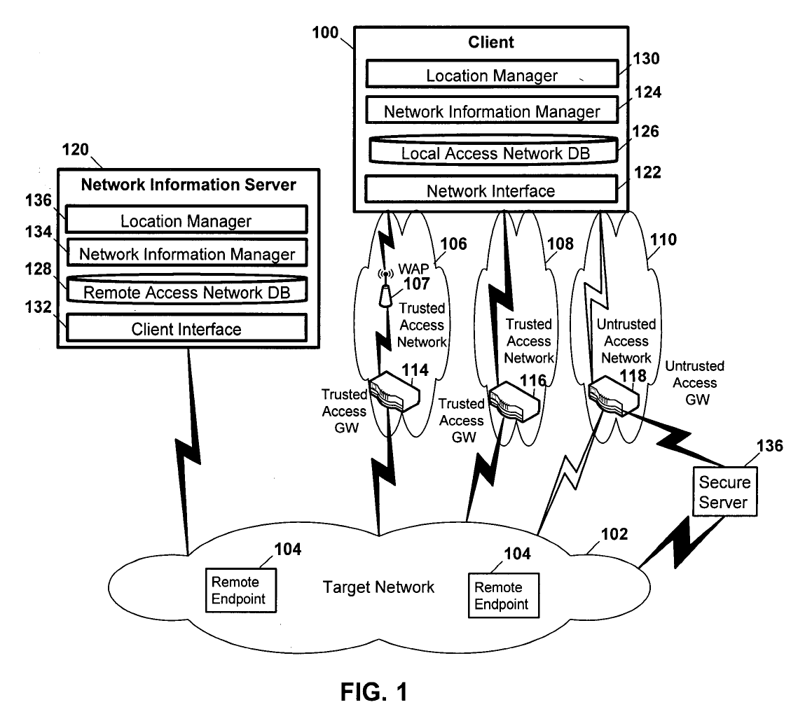

FIG. 1 is a schematic diagram illustrating a system for providing trusted access to a communication network based on location according to an aspect of the subject matter disclosed herein. In FIG. 1, a user of a client 100 is considering accessing a communication network 102 to communicate with one or more remote endpoints 104 accessible via network 102. For example, network 102 may be the Internet and remote endpoints 104 may be Internet sites accessible by client 100 once access is established to network 102. Alternatively, network 102 may be a metropolitan area network (MAN), wide area network (WAN), local area network (LAN), and the like, or any combination thereof. Since the user is considering accessing network 102, network 102 will be referred to herein as a “target network”. Client 100 may be any communication device, such as a computer, mobile phone, PDA, and the like.

Client 100 can access target network 102 via one of multiple available networks 106, 108, and 110 providing access to target network 102. Since these networks provide access to target network 102, each will be referred to herein as an “access network”. Access networks 106, 108, and 110 may include access gateways 114,116, and 118 to provide access to target network 102 either alone or in conjunction with the access networks 106,108, and 110, respectively. By way of example, access network 106 may include a Wi-Fi hotspot provided by a commercial establishment. That is, access network 106 may include a wireless access point (WAP) 112 for communicating wirelessly with client 100 when client 100 is within range of the Wi-Fi hotspot. Client 100 can communicate with target network 102 via access network 106. Note that additional networks, such as a LAN, an Internet service provider (ISP), and other entities not shown may also be employed along with access networks 106, 108, and 110 to provide access to target network 102.

As used herein, the term “access network” refers to one or more communication nodes providing communication between a client, such as client 100, and target network 102. The access network may include, for example, an access gateway, a wireless access point, routers, switches, and other such devices. For example, the access network may include an access gateway, such as access gateways 114, 116, and 118. In addition, or alternatively, the access network may include a set of communication nodes arranged to provide access to target network 102. In each case, the access network may include hard-wired, optical, or wireless components, or any combination thereof. In addition, an access network may include any of the number of protocols and software supporting communication via the access network, including security protocols. In each case, access network will be used herein to represent the above-described infrastructure and functionality.

It should also be understood that the term access network as used herein refers to a network that is, in whole or in part, under the control of an access network provider that may exercise control over the use of the access network to limit access thereto. Put another way, the access network provider may exercise some degree of control over communications via the access network to and from the target network. One example of an access network is a Wi-Fi hotspot providing controlled wireless access to the Internet (target network). The owner of the hotspot exercises control over access to the Internet by, e.g., imposing fees for the service, limiting availability of the access network, and a number of other control practices not normally associated with the Internet. Accordingly, an access network should not be considered as merely an extension of target network 102.

In FIG. 1, a network information server 120 may be accessed to determine information about access networks, including trust indication information, location information, access network identities, and other such information associated with access networks providing access to target network 102. Network information server 120 is separate from client 100, an access network provider, and an associated access network. That is, network information server 120 operates independently of client 100 and an access network, but may interface with both.

Client 100 includes means for detecting an available access network providing access to a target communication network. For example, client 100 may include a network interface 122 for detecting an available access network. Network interface 122 may detect an access gateway or WAP in the access network. For example, network interface 122 may receive a service set identifier (SSID) broadcast from a WAP. Network interface 122 may also detect an available access network using other known communication techniques.

Client 100 may also include means for determining whether the available access network is a trusted access network. For example, client 100 may include a network information manager 124 that determines whether the available access network is a trusted access network. Network information manager 124 may be configured to determine whether the available access network is a trusted access network by determining an access network identifier associated with the available access network and by determining, based on the access network identifier, whether the available access network is in an access network database. The access network identifier associated with the available access network may be based on an Internet protocol (IP) address for the access gateway associated with the available access network and/or an access point associated with the available access network. Using the IP address provides a unique address for devices in the access network. The IP address may be a permanent address or one that is dynamically assigned.

The access network identifier may also be based on a media access control (MAC) address for an access gateway associated with the available access network and/or an access point associated with the available access network. Using the MAC address provides a unique serial number associated with a network device that identifies the network device hardware to other network devices.

The access network identifier may also be based on an IP subnet identifier associated with the available access network. An IP subnet identifier is a portion (typically 8 bits) of an IP address that is common to devices within a network that is a subnetwork to another network. For example, a LAN or other network may be a subnetwork to the Internet. When a subnet identifier is employed with a class B IP address, sixteen bits represent the net ID, eight bits represent the subnet ID, and eight bits represent the host ID. All devices within the subnetwork will have the same subnetID.

The access network identifier may also be based on a signed digital certificate associated with the available access network. The signed digital certificate may be obtained from the access network. For example, an access gateway providing access to the target network may provide a signed digital certificate indicating an identity associated with the access network.

The access network identifier may also be based, in-part, on an SSID received from a wireless access point. The SSID is typically represented by a case-sensitive name assigned to a wireless Wi-Fi network used by devices in the Wi-Fi network to communicate. Although an SSID is not guaranteed to be unique, the SSID of a network can be combined with other information, such as the items described above, to form the access network identifier.

It should be understood that the access network identifier may also be based on any combination of the above discussed items. According to one aspect of the subject matter disclosed herein, network information manager 124 determines whether the available access network is in an access network database based on the access network identifier. For example, network information manager 124 may determine whether the available access network is in an access network database based on prior use of the access network or based on information provided by the access network. In one implementation, client 100 can receive a trust indication from an access gateway, WAP, or any communication node associated with the access network. In one implementation, when a broadcast SSID message is received at network interface 122, network information manager 124 extracts a trust indication from the SSID message. The trust indication may be absent in the case of untrusted access networks, or may include an associated trust level.

According to another aspect, client 100 may also include a local access network database 126. Network information manager 124 accesses local access network database 126 to determine based on the access network identifier whether the available access network is a trusted access network. For example, local access network database 126 may include network identifiers, such as those described above, and corresponding records indicating whether the available access network is a trusted access network. Network information manager 124 searches local access network database 126 to determine whether or not an available access network is a trusted access network. Trust indications may be determined and compiled in local access network database 126 as discussed above with reference to U.S. patent application Ser. Nos. 11/093,355 and 11/093,564.

According to another aspect, network information manager 124 in client 100 is configured to access a remote access network database 128 on network information server 120. Network information manager 124 sends a request to network information server 120 with the access network identifier to determine whether the available access network is trusted. Network information server 120 determines whether the available access network is trusted by, for example, accessing remote access network database 128 based on the access network identifier. Network information server 120 responds with an indication as to whether the identified access network is trusted.

According to another aspect, network information manager 124 accesses local access network database 126 to determine whether the available access network is in an access network database based on the access network identifier as described above. Responsive to not finding the access network identifier in local access network database 126 on client 100, network information manager 124 accesses remote access network database 128 on network information server 120. In one implementation, local access network database 126 on client 100 may include information about access networks within a given region or regions. For example, local access network database 126 may include information about access networks within regions covering a home area of a user of client 100 and commonly traveled regions of the user. Accordingly, local access network database 126 on client 100 may be checked first to determine if an access network identifier for the available access network is listed. In this example, remote access network database 128 is checked when client 100 is outside those regions and thus no matching local access network database 126 is available on client 100.

According to another aspect, when a local access network database 126 is included on client 100, network information server 120 may provide updates to client 100 for maintaining local access network database 126.

Client 100 may also include means for determining location information corresponding to the location of client 100. For example, client 100 may include a location manager 130 that determines location information for client 100. According to one aspect, location manager 130 is configured to determine location information for the communication device by determining an access network identifier associated with the available access network and accessing one or both of access network databases 126 and 128 to determine location information based on the access network identifier associated with the available access network. The access network identifier associated with the available access network may be based on at least one of an IP address, MAC address, IP subnet identifier, a signed digital certificate, and an SSID associated with the available access network, as described above. The location information may include an address, intersection, landmark, public area, and/or other location information.

According to another aspect, client 100 includes a global positioning system (GPS) receiver (not shown) that receives GPS location information from a global positioning system. Location manager 130 is configured to determine location information for the communication device based on the received GPS location information. GPS location information is determined by the GPS receiver in conjunction with a system of satellites. Generally speaking, the GPS receiver determines its latitude and longitude by calculating the time difference for signals from different satellites to reach the GPS receiver. Once the latitude and longitude are determined, location information may be determined by accessing a location database that cross-references the latitude and longitude information with more user-friendly location information, such as street addresses. The location information may be included in network database 126 and/or network database 128. Here, for example, GPS exchange format (GPX) may be used for transferring GPS data between client 100 and network information server 120. GPX is an extensible markup language (XML) schema designed for transferring GPS data between software applications.

According to another suspect, location manager 130 is configured to determine location information for client 100 by prompting a user of client 100 to input the location information. For example, a user may be prompted by a dialog box in a user interface on client 100. The user enters (or selects) the location information via the dialog box.

Client 100 also includes means for determining an identity of one or more trusted access networks based on the determined location information. For example, network information manager 124 may determine an identity of at least one trusted access network based on the determined location information. For example, network information manager 124 may be configured to access one or both of access network databases 126 and 128 to determine an identity of a trusted access network based on the determined location information. As described above with reference to access network trust indications, client 100 may access local access network database 126 on client 100 and, responsive to not finding the trusted access network identifier in local access network database 126, may access remote access network database 128 on network information server 120.

Network information server 120 includes means for receiving, from one or more clients 100, a request for an identity of at least one trusted access network for accessing a target communication network. For example, network information server 120 includes a client interface 132 that receives a request for an identity of at least one trusted access network for accessing target communication network 102 from one or more clients 100. The request includes at least one of an access network identifier associated with an access network currently available to the client and location information for the client. The access network identifier may include at least one of an IP address, a MAC address, an IP subnet identifier, a signed digital certificate, and a SSID associated with the available access network, as described above. The location information may include location information based on a global positioning system, such as GPX data received from client 100 based on a GPS receiver in client 100. For example, client 100 may contact network information server 120 to determine if an available access network is a trusted access network, to determine a location for an available access network, and/or to determine the location of trusted access networks based on location information.

Network information server 120 also includes means for determining corresponding information for at least one trusted access network based on at least one of a network identifier for an access network currently accessible to the client and location information for the client. For example, network information server 120 may include a network information manager 134 that determines corresponding information for at least one trusted access network based on at least one of a network identifier for an access network currently accessible to the client and location information for the client. Network information manager 134 determines corresponding information for the at least one trusted access network by accessing remote access network database 128.

Network information manager 134 may be configured to determine network characteristics of the trusted access networks. For example, trust indications of each of the trusted access networks, bandwidth availability of each of the trusted access networks, and/or quality of service of each of the trusted access networks may be determined. The trust indication may be determined as described in above-referenced U.S. patent application Ser. Nos. 11/093,355 and 11/093,564. Network information manager 134 may be configured to determine corresponding information only for trusted access networks that meet minimum network characteristics, such as minimum trust level, bandwidth availability, and/or quality of service.

Network information manager 134 may be configured to determine an identity of a secure server 136 providing secure communications with the target communication network. For example, when a trusted access network is not available for use or is not conveniently located, network information manager 134 may provide identities of one or more secure servers 136 that may be used for secure communications with target network 102, even via an untrusted access network.

Network information server 120 also includes means for forwarding the corresponding information for the at least one trusted access network to a client. For example, client interface 132 may forward the corresponding information for the at least one trusted access network to client 100. Alternatively, or in addition, network information manager 128 at client 100 may be configured to determine a secure server providing secure communications with target communication network 102.

Secure server 136 may be a VPN server, for example. Access to target network 102 may be established by tunneling to secure server 136. Tunneling involves encapsulating an entire packet of data within another packet and sending it via a network. The protocol of the encapsulating packet is understood by both the sending and receiving endpoints. Examples of protocols used for tunneling include IPSec, layer 2 tunneling protocol (L2TP), and point-to-point tunneling protocol (PPTP).

Network information server may also include a location manager 136 that determines location information for trusted access networks. The location information is obtained from remote access network database 128 based on an access network identifier provided by client 100. The location information for the trusted access networks is provided to client 100 via client interface 132.

With reference again to client 100, network information manager 124 may be configured to select one or more trusted access networks by automatically selecting a trusted access network meeting minimum network characteristics. Alternatively, network information manager 124 may be adapted to select between access networks based on a comparison of respective network characteristics of the available access networks. For example, network information manager 124 may automatically select an available access network offering the best quality of service. Client 100 may also be redirected to another access network based on network characteristics.

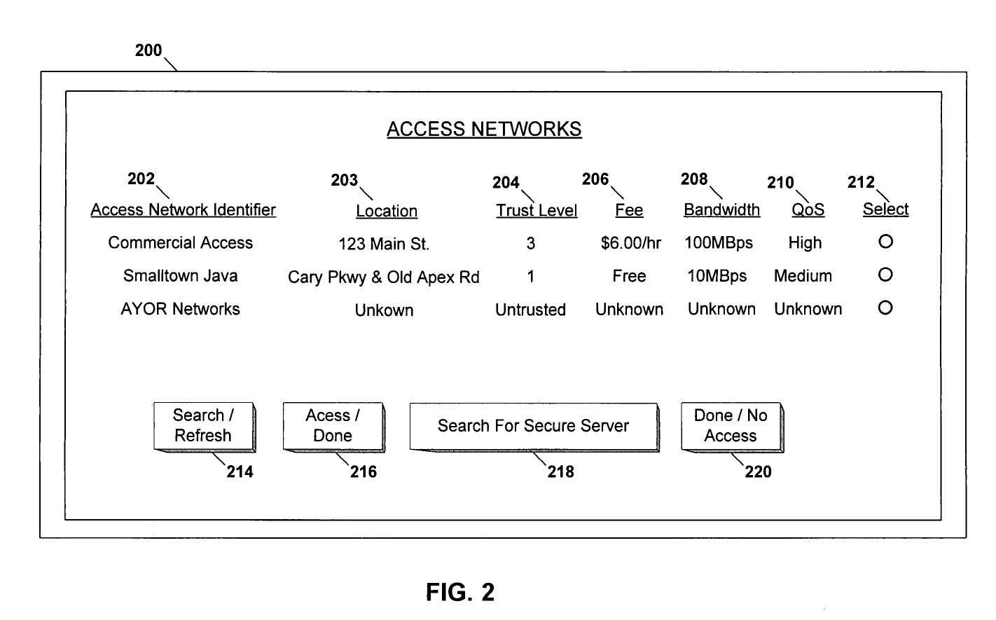

According to another aspect, client 100 may include a display and input device (not shown), or any form of user interface. Network information manager 124 controls the display of the trusted access network and corresponding network characteristics to a user on the display and controls the requesting of user input via the input device for selecting a trusted access network. FIG. 2 is a representation of a user interface 200 for selecting among access networks. For example, user interface 200 may be a window on a computer display.

In FIG. 2, user interface 200 includes access network identifiers 202 with corresponding location information 203, access network trust levels 204, access network fees 206, access network bandwidths 208, quality of service 210, and access network selection radio buttons 212. In addition, user interface 200 includes buttons for search/refresh 214, access/done 216, search for secure server 218, and done/no access 220. User interface 200 may be presented to a user to select an available access network. A user compares the available information and activates a corresponding radio button 212 to make a selection. Once a selection is made, access/done button 216 is activated to initiate access to target network 102 via the selected access network. Alternatively, done/no access button 220 may be activated to signify the user is not satisfied with any of the available access networks and chooses not to access target network 102. Search/Refresh button 214 may be activated to initiate or reinitiate a search for available access networks.

Button 218 may be used to initiate a search for a secure server. When button 218 is activated, a list of available secure servers is presented in user interface 200 for selection. Referring again to FIG. 1, a secure server 136 is shown. When client 100 establishes communication with untrusted access gateway 118, network information manager 124 may determine a list of secure servers accessible to access gateway 118 to provide a secure connection to target network 102.

The access networks listed in FIG. 2 may be gathered by network information manager based on networks that are detected via network interface 122 and/or are retrieved from access network databases 126 and/or 128 based on location information. For example, networks may be listed that have a location 123 within a given radius of the current location of client 100. The radius may be fixed or configurable by a user of client 100.

It will be understood that FIG. 2 illustrates one possible implementation of a user interface. As will be appreciated, not all of the information need be provided and additional information and functionality may be provided in a user interface.

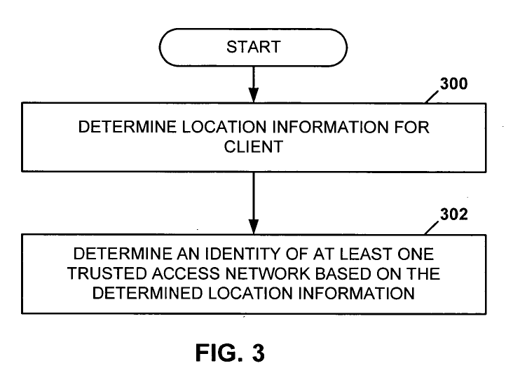

FIG. 3 is a flow diagram illustrating a method for providing trusted access to a communication network by a client based on location according to an aspect of the subject matter described herein. In FIG. 3, location information for the client is determined in block 300 using any of the methods described above. In block 302, an identity of at least one trusted access network is determined based on the determined location information. As described above, one or both of access network databases 126 and 128 may be accessed to determine the identity of the at least one trusted access network based on the location information.

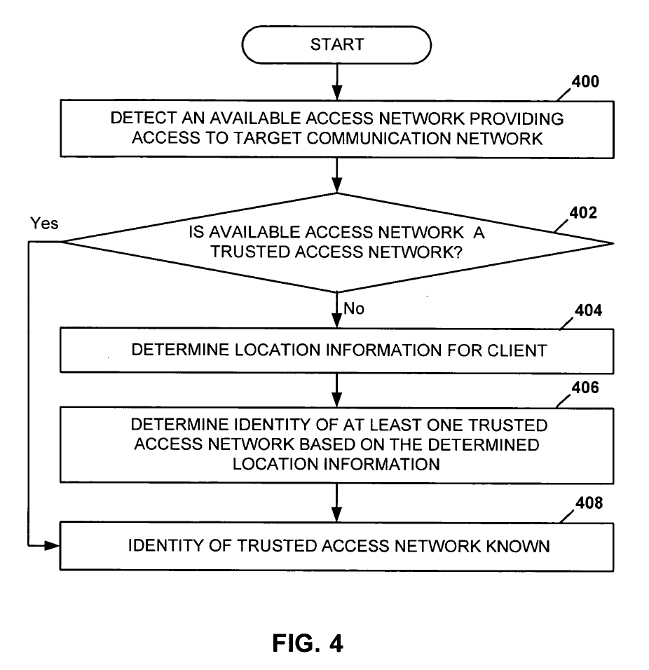

FIG. 4 is a flow diagram illustrating a method for providing trusted access to a communication network by a client based on location according to another aspect of the subject matter described herein. In FIG. 4, an available access network providing access to a target communication network is detected by network interface 122 in block 400. In block 402, network information manager 124 determines whether the available access network is a trusted access network. Responsive to network information manager 124 determining that the available access network is not a trusted access network in block 402, location manager 130 determines location information for the client in block 404. In block 406, an identity of at least one trusted access network is determined based on the determined location information. Accordingly, the identity of the trusted access network is known, as indicated by block 408. Returning to block 402, the identity of the trusted access network may also be known responsive to network information manager 124 determining that the available access network is a trusted access network.

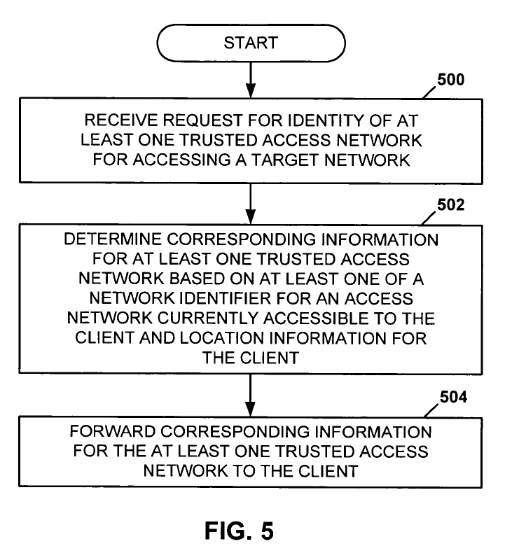

FIG. 5 is a flow diagram illustrating a method for providing trusted access to a communication network to a client based on location according to another aspect of the subject matter described herein. In FIG. 5, a request for an identity of at least one trusted access network for accessing a target communication network is received by client interface 132 of network information server 120 from a client in block 500. The request includes at least one of an access network identifier associated with an access network currently available to the client and location information for the client. In block 502, corresponding information for at least one trusted access network is determined based on the network identifier and/or location information for the client. The corresponding information for the at least one trusted access network is forwarded to the client in block 504.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing trusted access to a communication network by a client based on location, the method comprising:
at a client:
(a) detecting an available access network providing access to a target communication network;
(b) determining whether the available access network is a trusted access network;
(c) responsive to determining that the available access network is not a trusted access network, determining location information for the client; and
(d) determining an identity of at least one trusted access network based on the determined location information.

2. The method of claim 1 wherein detecting an available access network providing access to a target communication network includes detecting at least one of an access gateway and a wireless access point

3. The method of claim 1 wherein determining whether the available access network is a trusted access network comprises:
(a) determining an access network identifier associated with the available access network; and
(b) determining, based on the access network identifier, whether the identifier associated with the available access network is in an access network database.

4. The method of claim 3 wherein determining an access network identifier associated with the available access network includes at least one of:
(a) determining an Internet protocol (IP) address for at least one of an access gateway associated with the available access network and an access point associated with the available access network;
(b) determining a media access control (MAC) address for at least one of an access gateway associated with the available access network and an access point associated with the available access network;
(c) determining an IP subnet identifier associated with the available access network;
(d) receiving a signed digital certificate associated with the available access network; and
(e) receiving a service set identifier (SSID) associated with the available access network.

5. The method of claim 3 wherein determining whether the identifier associated with the available access network is in an access network database based on the access network identifier includes at least one of:
(a) accessing a local access network database on the client; and
(b) accessing a remote access network database on a server.

6. The method of claim 3 wherein determining whether the identifier associated with the available access network is in an access network database comprises:
(a) accessing a local access network database on the client; and
(b) responsive to not finding the access network identifier in the local access network database, accessing a remote access network database on a server.

7. The method of claim 1 wherein determining location information for the client comprises:
(a) determining an access network identifier associated with the available access network; and
(b) accessing an access network database to determine location information associated with the available access network based on the access network identifier.

8. The method of claim 7 wherein determining an access network identifier associated with the available access network comprises at least one of:
(a) determining an IP address for at least one of an access gateway associated with the available access network and an access point associated with the available access network;
(b) determining a MAC address for at least one of an access gateway associated with the available access network and an access point associated with the available access network;
(c) determining an IP subnet identifier associated with the available access network;
(d) receiving a signed digital certificate associated with the available access network; and
(e) receiving a service set identifier (SSID) associated with the available access network.

9. The method of claim 7 wherein accessing an access network database to determine location information based on the access network identifier associated with the available access network comprises at least one of:
(a) accessing a local access network database on the client; and
(b) accessing a remote access network database on a server.

10. The method of claim 1 wherein determining location information for the client includes determining location information using a global positioning system.

11. The method of claim 1 wherein determining location information for the client comprises:
(a) prompting a user of the client to input the location information; and
(b) determining location information based on the user input.

12. The method of claim 1 wherein determining an identity of at least one trusted access network based on the determined location information comprises at least one of:
(a) accessing a local access network database on the client; and
(b) accessing a remote access network database on a server.

13. The method of claim 1 wherein determining an identity of at least one trusted access network based on the determined location information comprises:
(a) accessing a local access network database on the client; and
(b) responsive to not finding the trusted access network identifier in the local access network database, accessing a remote access network database on a server.

14. The method of claim 1 wherein determining an identity of at least one trusted access network based on the determined location information includes determining a secure server providing secure communications with the target communication network.

15. The method of claim 14 comprising tunneling from the client to the secure server.

16. The method of claim 1 comprising accessing the target communication network via one of the at least one trusted access networks.

17. The method of claim 1 comprising selecting one of the at least one trusted access networks based on a comparison of network characteristics of the trusted access networks.

18. The method of claim 17, wherein the network characteristics comprise at least one of trust indications of each of the trusted access networks, bandwidth availability of each of the trusted access networks, quality of service of each of the trusted access networks.

19. The method of claim 17 wherein selecting one of the at least one trusted access networks based on a comparison of network characteristics of the trusted access networks comprises:
(a) displaying the trusted access network and corresponding network characteristics to a user; and
(b) requesting user input for selecting a trusted access network.

20. The method of claim 17 wherein selecting one of the at least one trusted access networks based on a comparison of network characteristics of the trusted access networks comprises includes automatically selecting a trusted access network having at least minimum network characteristics.

21. A method for providing trusted access to a communication network by a client based on location, the method comprising:
at a client:
(a) determining location information for the client; and
(b) determining an identity of at least one trusted access network based on the determined location information.

22. A method for providing trusted access to a communication network to a client based on location, the method comprising:
at a server:
(a) receiving, from a client, a request for an identity of at least one trusted access network for accessing a target communication network, the request including at least one of an access network identifier associated with an access network currently available to the client and location information for the client; and
(b) determining corresponding information for at least one trusted access network based on the at least one of a network identifier for an access network currently accessible to the client and location information for the client; and
(c) forwarding the corresponding information for the at least one trusted access network to the client.

23. The method of claim 22 wherein the access network identifier associated with an access network currently accessible to the client includes at least one of:
(a) an IP address for at least one of an access gateway associated with the available access network and an access point associated with the available access network;
(b) a MAC address for at least one of an access gateway associated with the available access network and an access point associated with the available access network;
(c) an IP subnet identifier associated with the available access network;
(d) a signed digital certificate associated with the available access network; and
(e) a SSID associated with the available access network.

24. The method of claim 22 wherein the location information for the client includes location information using a global positioning system.

25. The method of claim 22 wherein determining corresponding information for at least one trusted access network based on the at least one of a network identifier for an access network currently accessible to the client and location information for the client includes accessing a remote access network database on the server.

26. The method of claim 22 wherein determining corresponding information for at least one trusted access network based on the at least one of a network identifier for an access network currently accessible to the client and location information for the client includes determining location information for the at least one trusted access network.

27. The method of claim 22 wherein determining corresponding information for at least one trusted access network based on the at least one of a network identifier for an access network currently accessible to the client and location information for the client includes determining an identity of a secure server providing secure communications with the target communication network.

28. The method of claim 22 wherein determining corresponding information for at least one trusted access network based on the at least one of a network identifier for an access network currently accessible to the client and location information for the client includes determining network characteristics of the trusted access networks.

29. The method of claim 28 wherein the network characteristics comprise at least one of trust indications of each of the trusted access networks, bandwidth availability of each of the trusted access networks, quality of service of each of the trusted access networks.

30. The method of claim 28 wherein determining corresponding information for at least one trusted access network based on the at least one of a network identifier for an access network currently accessible to the client and location information for the client includes determining whether a trusted access network has at least minimum network characteristics.

31. A computer program product comprising computer executable instructions embodied in a computer-readable medium for performing steps comprising:
at a client:
(a) detecting an available access network providing access to a target communication network;
(b) determining whether the available access network is a trusted access network;
(c) responsive to determining that the available access network is not a trusted access network, determining location information for the client; and
(d) determining an identity of at least one trusted access network based on the determined location information.

32. A computer program product comprising computer executable instructions embodied in a computer-readable medium for performing steps comprising:
at a server:
(a) receiving, from a client, a request for an identity of at least one trusted access network for accessing a target communication network, the request including at least one of an access network identifier associated with an access network currently available to the client and location information for the client; and
(b) determining corresponding information for at least one trusted access network based on the at least one of a network identifier for an access network currently accessible to the client and location information for the client; and
(c) forwarding the corresponding information for the at least one trusted access network to the client.

33. A communication device for providing trusted access to a communication network based on location, comprising:
(a) means for detecting an available access network providing access to a target communication network;
(b) means for determining whether the available access network is a trusted access network;
(c) means for determining location information for the client; and
(d) means for determining an identity of at least one trusted access network based on the determined location information.

34. A communication device for providing trusted access to a communication network based on location, the method comprising:
(a) a network interface that detects an available access network providing access to a target communication network;
(b) a location manager that determines location information for the communication device, and
(c) a network information manager that determines whether the available access network is a trusted access network and, responsive to determining that the available access network is not a trusted access network, determines an identity of at least one trusted access network based on the determined location information.

35. The communication device of claim 34 wherein the network interface is configured to detect at least one of an access gateway and a wireless access point.

36. The communication device of claim 34 wherein the location manager is configured to determine location information for the communication device by:
(a) determining an access network identifier associated with the available access network; and
(b) accessing an access network database to determine location information based on the access network identifier associated with the available access network.

37. The communication device of claim 34 wherein the location manager is configured to determine an access network identifier associated with the available access network based on at least one of:
(a) an IP address for at least one of an access gateway associated with the available access network and an access point associated with the available access network;
(b) a MAC address for at least one of an access gateway associated with the available access network and an access point associated with the available access network;
(c) an IP subnet identifier associated with the available access network;
(d) a signed digital certificate associated with the available access network; and
(e) a service set identifier (SSID) associated with the available access network.

38. The communication device of claim 34 comprising a local access network database, wherein the location manager is configured to access the local access network database to determine location information based on the access network identifier associated with the available access network.

39. The communication device of claim 34 wherein the location manager is configured to access a remote access network database on a server to determine location information based on the access network identifier associated with the available access network.

40. The communication device of claim 34 comprising a global positioning system (GPS) receiver that receives GPS location information from a global positioning system, wherein the location manager is configured to determine location information for the communication device based on the received GPS location information.

41. The communication device of claim 34 wherein the location manager is configured to determine location information for the communication device by:
(a) prompting a user of the communication device to input the location information; and
(b) determining location information based on the user input.

42. The communication device of claim 34 wherein the network information manager is configured to determine whether the available access network is a trusted access network by:
(a) determining an access network identifier associated with the available access network; and
(b) determining whether the identifier associated with the available access network is in an access network database.

43. The communication device of claim 42 wherein, the network information manager is configured to determine the access network identifier associated with the available access network based on at least one of:
(a) an IP address for at least one of an access gateway associated with the available access network and an access point associated with the available access network;
(b) a MAC address for at least one of an access gateway associated with the available access network and an access point associated with the available access network;
(c) an IP subnet identifier associated with the available access network;
(d) a signed digital certificate associated with the available access network; and
(e) a SSID associated with the available access network.

44. The communication device of claim 42 comprising a local access network database, wherein the network information manager is configured to access the local access network database to determine whether the available access network is a trusted access network.

45. The communication device of claim 42 wherein the network information manager is configured to access a remote access network database on a server to determine whether the available access network is a trusted access network.

46. The communication device of claim 42 wherein the network information manager is configured to determine whether the identifier associated with the available access network is in an access network database by:
(a) accessing a local access network database on the communication device; and
(b) responsive to not finding the access network identifier in the local access network database, accessing a remote access network database on a server.

47. The communication device of claim 34 comprising a local access network database, wherein the network information manager is configured to determine an identity of at least one trusted access network based on the determined location information by accessing the local access network database on the communication device.

48. The communication device of claim 34 wherein the network information manager is configured to determine an identity of at least one trusted access network based on the determined location information by accessing a remote access network database on a server.

49. The communication device of claim 34 wherein the network information manager is configured to determine an identity of at least one trusted access network based on the determined location information by:
(a) accessing a local access network database on the communication device; and
(b) responsive to not finding the trusted access network identifier in the local access network database, accessing a remote access network database on a server.

50. The communication device of claim 34 wherein the network information manager is configured to determine an identity of at least one trusted access network based on the determined location information by determining a secure server providing secure communications with the target communication network.

51. The communication device of claim 50 wherein the network information manager is configured to tunnel to the secure server.

52. The communication device of claim 34 wherein the network information manager is configured to select one of the at least one trusted access networks based on a comparison of network characteristics of the trusted access networks.

53. The communication device of claim 52 wherein the network characteristics comprise at least one of trust indications of each of the trusted access networks, bandwidth availability of each of the trusted access networks, quality of service of each of the trusted access networks.

54. The communication device of claim 52 comprising a display and input device, wherein the network information manager is configured to select one of the at least one trusted access networks by:
(a) displaying the trusted access network and corresponding network characteristics to a user on the display; and
(b) requesting user input via the input device for selecting a trusted access network.

55. The communication device of claim 52 wherein the network information manager is configured to select one of the at least one trusted access networks by automatically selecting a trusted access network having at least minimum network characteristics.

56. A server for providing trusted access to a communication network by a client, the server comprising:
(a) means for receiving, from a client, a request for an identity of at least one trusted access network for accessing a target communication network, the request including at least one of an access network identifier associated with an access network currently available to the client and location information for the client; and
(b) means for determining corresponding information for at least one trusted access network based on the at least one of a network identifier for an access network currently accessible to the client and location information for the client; and
(c) means for forwarding the corresponding information for the at least one trusted access network to the client.

57. A server for providing trusted access to a communication network by a client, the server comprising:
(a) a client interface that receives, from a client, a request for an identity of at least one trusted access network for accessing a target communication network, the request including at least one of an access network identifier associated with an access network currently available to the client and location information for the client; and
(b) a network information manager that determines corresponding information for at least one trusted access network based on the at least one of a network identifier for an access network currently accessible to the client and location information for the client, wherein the client interface forwards the corresponding information for the at least one trusted access network to the client.

58. The server of claim 57 wherein the access network identifier associated with an access network currently accessible to the client includes at least one of:
(a) an IP address for at least one of an access gateway associated with the available access network and an access point associated with the available access network;
(b) a MAC address for at least one of an access gateway associated with the available access network and an access point associated with the available access network;
(c) an IP subnet identifier associated with the available access network;
(d) a signed digital certificate associated with the available access network; and
(e) a SSID associated with the available access network.

59. The server of claim 57 wherein the location information for the client includes location information using a global positioning system.

60. The server of claim 57 wherein the network information manager is configured to determine corresponding information for the at least one trusted access network by accessing an access network database.

61. The server of claim 57 comprising a location manager, wherein the location manager is configured to determine location information for the at least one trusted access network by accessing an access network database.

62. The server of claim 57 wherein the network information manager is configured to determine corresponding information for at least one trusted access network by determining an identity of a secure server providing secure communications with the target communication network.

63. The server of claim 57 wherein the network information manager is configured to determine corresponding information for at least one trusted access network by determining network characteristics of the trusted access networks.

64. The server of claim 63 wherein the network characteristics comprise at least one of trust indications of each of the trusted access networks, bandwidth availability of each of the trusted access networks, quality of service of each of the trusted access networks.

65. The server of claim 57 wherein the network information manager is configured to determine corresponding information for at least one trusted access network by determining a trusted access network having at least minimum network characteristics.
